(19) United States
(12) Patent Application Publication
(10) Pub. No.: US 2024/0255921 A1
(43) Pub. Date: Aug. 1, 2024

(54) POLICY-BASED ENGINEERING FOR INDUSTRIAL AUTOMATION

(71) Applicant: Siemens Aktiengesellschaft, Munich (DE)

(72) Inventors: Yunhua Fu, Princeton, NJ (US); Hartmut Ludwig, West Windsor, NJ (US); Gustavo Arturo Quiros Araya, Princeton, NJ (US); Tejashree Kate, Princeton, NJ (US); Michael Jaentsch, Princeton, NJ (US); Florian Ersch, Plainsboro, NJ (US)

(21) Appl. No.: 18/262,398

(22) PCT Filed: Feb. 23, 2021
(86) PCT No.: PCT/US2021/019152

§ 371 Date: Jul. 21, 2023

(51) Int. Cl. G05B 19/4155

(52) U.S. Cl. CPC G05B 19/4155; G05B 2219/31229

(57) ABSTRACT

Industrial automation systems are often inflexible, which can result in delays or downtimes that are costly and inconvenient. In particular, it is recognized herein that the engineering phase of automation system implementation currently represents a significant portion of the overall cost of an automation system. As described herein, automation system configurations can be automatically generated in accordance with various policies that can be implemented at runtime.

### BACKGROUND

Industrial automation systems can be used to control the operation of machines and other components in a systematic manner. Automation systems can include various automation domains such as factory automation, process automation, building automation, energy automation, and the like. Automation systems can also include equipment from multiple vendors. In some cases, equipment and machines within an automation system may use varying mechanisms associated with their respective ecosystems, such as varying runtime environments, protocols, and programming languages (e.g., vendor-specific programming languages). By way of example, automation functions are often platform-specific and/or are implemented in a proprietary manner. Thus, generating an automation function that is interoperable with other automation functions can be cumbersome and time-consuming.

Further, today's automation systems are often hard-wired, such that hardware (e.g., production machines, robots, CNC machines) is bound with software in a particular configuration at an engineering phase. For example, industrial automation systems today often consist of hardware devices with general-purpose firmware (system software) that is configured for a specific task at hand. Operators, in turn, typically work with such an automation system on a day-to-day basis to change parameter settings and execute system functions. As a result, today's automation systems often lack flexibility to adapt to changes in a given plant, machine, or production process. In particular, such changes typically require an automation engineer because operators do not have the ability to reconfigure or reprogram the system. In some cases, when there is a new requirement (e.g., new hardware) for the system or the system otherwise needs to be reconfigured, such a system is stopped from operating while it is re-engineered or reconfigured.

It is recognized herein that such inflexible systems can result in delays that are costly and inconvenient. It is also recognized herein that the engineering phase of automation system implementation currently represents a significant portion of the overall cost of an automation system.

### BRIEF SUMMARY

Embodiments of the invention address and overcome one or more of the described-herein shortcomings or technical problems by providing methods, systems, and apparatuses for automatically generating automation system configurations based on various polices.

In an example aspect, a method can be performed in an industrial system that includes a plurality of machines that define respective hardware and automation skills associated with the hardware. A control module of the industrial system can obtain a first request for a first automation skill. Based on the first request, the control module can send a discovery call for identifying machines within the industrial system capable of providing the first automation skill. A policy handler rule engine an intercept the discovery call. Based on the discovery call, the policy handler rule engine can determine a policy associated with the first request. Based on the policy and during runtime of the industrial system, a first machine of the plurality of machines can be selected. The control module can trigger the first machine to perform the first automation skill. In some examples, during runtime, the system can identify a change in policy associated with the first request. For example, based on the change in policy associated with the first request, the control module can select a second machine of the plurality of machines, and trigger the second machine to perform the first automation skill. In another example, the control module can obtain a second request for the first automation skill. Further, based on the policy and during runtime of the industrial system, the control module can determine a second machine of the plurality of machines that is different than the first machine, and trigger the second machine to perform the first automation skill. In some cases, the policy can define rules for selecting the machines, and the rules can be based on a location in which the first automation skill is performed.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram of an example automation system that includes a control module, in accordance with an example embodiment.

FIG. 2 is a block diagram that illustrates another example automation system and messages that are transmitted within the automation system, in accordance with an example embodiment.

FIG. 3 depicts an example policy runtime server, in accordance with an example embodiment.

FIG. 4 shows an example of a computing environment within which embodiments of the disclosure may be implemented.

### DETAILED DESCRIPTION

By way of introduction, industry 4.0 represents the trend toward automation and data exchange in manufacturing technologies and processes, which can include cyber-physical systems (CPS), the internet of things (IOT), industrial internet of things (IIOT), cloud computing, cognitive computing, and artificial intelligence. Factories that represent industry 4.0 can include machines that are augmented with wireless connectivity capabilities and sensors, which can be connected to system that can visualize the entire production line and make decisions on its own. It is recognized herein that adaptive behavior is particularly important for such systems. It is further recognized herein that adaptive behavior can be enabled by allowing functions to be selected and configured at runtime and during engineering time. Various embodiments described herein define scalable low-cost approaches for selecting functions and configuring systems at runtime. For example, in accordance with embodiments described herein, automation functions can be interconnected and re-used in a flexible manner so as to enable operators without programming skills to manage various automation tasks.

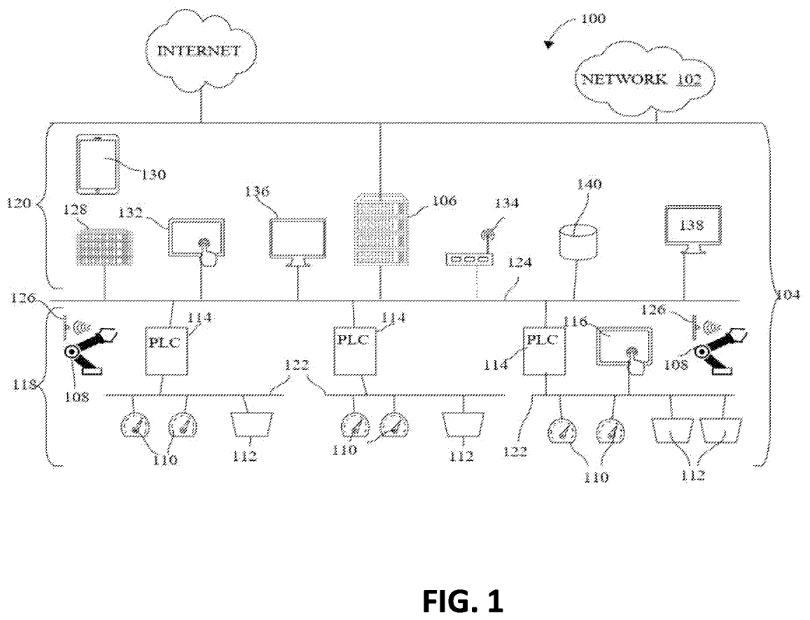

Referring initially to FIG. 1, an example automation system 100 includes multiple subsystems that contain control logic, host web servers, and the like. For example, the automation system can include an office or corporate IT network 102 and an operational plant or production network 104 communicatively coupled to the IT network 102. The production network 104 can include a plurality of control modules 106 throughout the production network 104. An example control module 106 is connected to the IT network 102. The arrangement of control modules 106 can vary as desired, and all such arrangements are contemplated as being within the scope of this disclosure. For example, control modules 106 can be distributed such that each component within the production network 104 can define the control module 106. For example, the control module 106 can define software that runs on components within the production network 104. Thus, the control units 106 can be arranged in a hierarchy. The production network 104 can include various production machines configured to work together to perform one or more manufacturing operations. Example production machines of the production network 104 can include, without limitation, robots 108 and other field devices that can be controlled by a respective PLC 114, such as sensors 110, actuators 112, or other machines, such as automatic guided vehicles (AGVs). In various examples, a given AGV defines the control module 106. The PLC 114 can send instructions to respective field devices. In some cases, a given PLC 114 can be coupled to a human machine interfaces (HMIs) 116. It will be understood that the automation system 100 is simplified for purposes of example. That is, the automation system 100 may include additional or alternative nodes or systems, for instance other network devices, that define alternative configurations, and all such configurations are contemplated as being within the scope of this disclosure.

The automation system 100, in particular the production network 104, can define a fieldbus portion 118 and an Ethernet portion 120. For example, and without limitation, the fieldbus portion 118 can include the robots 108, PLC 114, sensors 110, actuators 112, HMIs 116, and AGVs. The fieldbus portion 118 can define one or more production lines or control zones. The PLC 114, sensors 110, actuators 112, and HMI 116 within a given production line can communicate with each other via a respective field bus 122. Each control zone can be defined by a respective PLC 114, such that the PLC 114, and thus the corresponding control zone, can connect to the Ethernet portion 120 via an Ethernet connection 124. The robots 108 and AGVs can be configured to communicate with other devices within the fieldbus portion 118 via a Wi-Fi connection 126. Similarly, the robots 108 and AGVs can communicate with the Ethernet portion 120, in particular a Supervisory Control and Data Acquisition (SCADA) server 128, via the Wi-Fi connection 126. The Ethernet portion 120 of the production network 104 can include various computing devices or subsystems communicatively coupled together via the Ethernet connection 124. Example computing devices or subsystems in the Ethernet portion 120 include, without limitation, a mobile data collector 130, HMIs 132, the SCADA server 128, the control unit 106, a wireless router 134, a manufacturing execution system (MES) 136, an engineering system (ES) 138, and a log server 140. The ES 138 can include one or more engineering works stations. In an example, the MES 136, HMIs 132, ES 138, and log server 140 are connected to the production network 104 directly. The wireless router 134 can also connect to the production network 104 directly. Thus, in some cases, mobile users, for instance the mobile data collector 130 and robots 108 (e.g., AGVs), can connect to the production network 104 via the wireless router 134.

Example users of the automation system 100 include, for example and without limitation, operators of an industrial plant or engineers that can update the control logic of a plant. By way an example, an operator can interact with the HMIs 132, which may be located in a control room of a given plant. Alternatively, or additionally, an operator can interact with HMIs of the system 100 that are located remotely from the production network 104. Similarly, for example, engineers can use the HMIs 116 that can be located in an engineering room of the automation system 100. Alternatively, or additionally, an engineer can interact with HMIs of the automation 100 that are located remotely from the production network 104.

The automation system 100 can include different models of human machine interfaces (HMIs) 116, programmable logic controllers (PLCs) 114, robots 108, and the like, which can be also be from different manufacturers. By way of further example, in some cases, the automation system 100 can include one or more automatic guided vehicles (AGVs) that can operate in different rooms or portions of a factor or plant so as to perform different tasks. As described herein, it is recognized herein that changes to automation systems, such as hardware changes to the automation system 100, currently can require that production is stopped and machines are reprogrammed before the system is recommissioned.

The engineering phase of automation system implementation typically consists of programming and configuration. By way of example, programming generally includes the development of the logic of the system (e.g., conditions) and configuration generally includes the adjustment of parameters of the system. It is recognized herein that programming and configuration are tightly coupled in today's automation system implementations. By way of example, Siemens Totally Integrated Automation (TIA) Portal projects typically begin with hardware configuration that is followed by programming. In some cases, the engineered design is refined via iterations of changing the configuration or programming and evaluating the effects on the other of the configuration or programming. Further, it is recognized herein that existing automation engineering approaches typically hardcode the software to the hardware, which can force the iterative process for engineering described above. It is further recognized herein that, in existing approaches, changes during runtime can also force further iterations and refinements of engineering (or re-engineering).

In accordance with various embodiments described herein, programming can be front-loaded and configuration can be back-loaded. Front-loading generally refers to programming that is done prior to configuration, before runtime. Back-loading generally refers to configuration that is performed after programming is performed, or during runtime. In particular, in an example, the automation system 100 determines and selects hardware on which to run automation code at runtime, so as to reduce front-loading time and cost associated with the engineering phase. It is recognized herein that such increased back-loading operations can introduce technical problems associated with implementing and managing the interconnection of flexible and reusable automation functions and configurations. Various embodiments described herein address these issues, among others.

Engineering an industrial automation system typically includes various tasks, such as programming (implementing) automation functions, configuring the system, testing the system, commissioning the system, and maintaining the system. Implementing automation functions can include programming automation functionality for specific hardware, which can inhibit re-use of the automation functions. Further, current approaches to engineering automation systems can require reimplementation of control logic when the hardwired/hardcoded automation system is updated. For example, the automation system might need to be updated to work in different environments or situations, or to change hardware (e.g., IOs). In particular, an automation engineer may need to change (e.g., add, update, replace) hardware or software modules for new control logic. Further, an operator may need to shut down the automation system to update the system, and then restart the system with the updated functionality. By way of further example of existing approaches to engineering automation systems, suppose a factory is updating a production line according to an energy price change, such as by adjusting production parameters. To automate control so as to perform the update, the factory might need to, for example, add a control machine, develop a new HMI application, perform testing, shut down and restart the system with additional controls, or the like. Further, if the energy price changes again, the HMI application may need to be reprogrammed and/or other operations may need to be repeated.

As described above, such updates to hardwired/hardcoded automation systems can increase various costs related to hardware and software development, and system downtime. In accordance with various embodiments, backloading various engineering tasks can reduce cost associated with software development and system downtime, for example, by reducing time associating with adapting the system. In accordance with various embodiments, automation functions and various automation configurations can be selected and implemented in a flexible and automated manner that is accessible by engineers and operators alike.

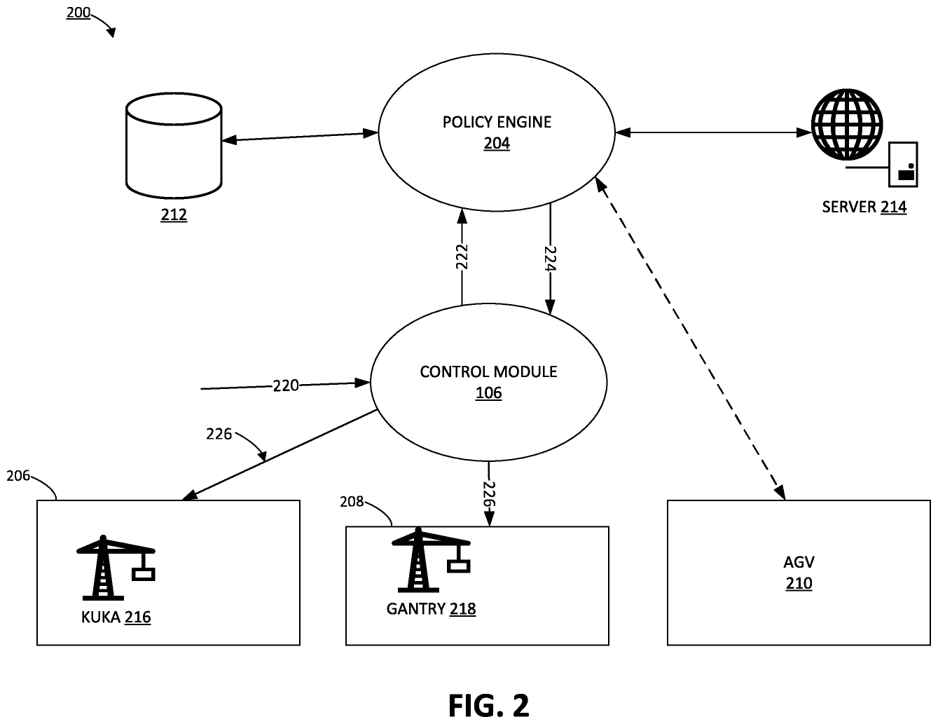

Referring now to FIG. 2, automation systems, for instance the automation system 100 or another example automation system 200, can include the control module 106 configured to intercept and process messages, for instance discovery calls. The system 200 can further include a policy handler rule engine 204 that can be configured to execute rules, for example, based on algorithms based on the Rete algorithm or the like. In some cases, the policy handler rule engine 204 can store various rules and policies. In various examples, the policy handler rule engine 204 manages rule chaining, wherein a rule's execution result triggers another rule's execution. The policy handler rule engine 204 can further be configured to filter calls based on its rules and policies, so as to determine how the call is processed. Based on determinations of the policy handler rule engine 204, the control module 106 can perform actions, such as, for example and without limitation, blocking a given call, selecting automation functions, selecting settings, selecting or adjusting return values, or the like. In some examples, the policy handler rule engine 204 can be configured to operate as a plug-in of the control module 106. In an example, control module 106 can intercept a skill request and the policy handler rule engine 204 can filter the skill request so as to determine skill providers that can meet the skill request.

The automation system 200 can include various subsystems and devices that define decision points. For example, the automation system can include a first subsystem 206, a second subsystem 208, and one or more automated guided vehicle (AGVs) 210. Decision points, for instance the first subsystem 206, the second subsystem 208, and the AGV 210, can make various determinations, such as which function to use, which set of parameters to use, or the like. In some cases, the control module 106 can define a domain model translator layer configured to translate different domain models. For example, the control module 106 can translate a domain model of a given decision point to a different domain model of the policy handler rule engine 204. In some cases, the model used in the function component is mapped or translated to the model in the rule engine 204 so that the rule engine can understand the message. By way of example, a request may concern a car, but the rules engine might only understand automobile, and thus the request needs to be translated.

In some examples, the system 200 also can include a database or repository, for instance a policy repository 212, configured to store policies and rules. A given policy can refer to a group of rules. As used herein, policies and rules can be used interchangeably without limitation, unless otherwise specified. Policies can relate to different adaptive behavior situations. For example, a policy may stipulate a maximum speed for the AGV 210 given a particular location. In various examples, rules can apply to specific conditions for specific behavior, such that the rules resolve to true or false. An example rule may define a higher maximum speed when the AGV 210 is in a specific hall where there are limited humans, as compared to a lower maximum speed when the AGV 210 is in a lobby where there are generally more humans. By way of further example, an operator may stipulate a location in which the AGV 210 will operate, and policy associated with the AGV and/or location may determine a configuration of the AGV 210. The automation system can further include one or more web servers or tools/browsers, for instance a web server 214, configured to monitor the execution of policies and rules. A user can also manage policies and rules associated with the policy handler rule engine 204, via the web server 214 or any alternative input/output application, not limited to the web.

It should be appreciated that functionality described as being supported by program modules of the automation system 200 may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules. Thus, it will be also understood that the automation system 200 is simplified to illustrate an example, and the automation system 200 can vary as desired, and all such automation systems are contemplated as being within the scope of this disclosure.

In various embodiments, programming for selecting functions and configurations is replaced with runtime rule application, so as to define policy-based engineering. For example, predefined polices can be loaded into the policy handler rule engine 204 during system startup. A runtime decision point, for instance the subsystem 206, subsystem 208, or the AGV 210, can utilize the policy handler rule engine 204 to make decisions. During runtime, a user can update, add, or delete policies from the policy repository 212 or the policy handler rule engine 204. Further, during runtime, the user can monitor the execution of policies and rules.

By way of example, the automation system 200 can include a production line that can be configured to produce multiple products, such that multiple products can share the production line. The production line can perform a skill-based production process. For example, the production line, in particular the first subsystem 206, can define a Kuka station 216 configured to pick production parts. The production line, in particular the second subsystem 208, can define a gantry station 218 configured to pick production parts. In the example, the Kuka station 216 is faster and more expensive than the gantry station 218. Thus, an example policy may stipulate that a first product is high priority, and a second product is low priority. Based on the policies, during runtime, the control module 106 might only use the gantry station 218 to pick the parts for the second product. In contrast, based on the policies, during runtime, the control module 106 may use the Kuka station 216 or the gantry station 218 to pick the parts for the first product. In particular, for example, a request message may indicate a type associated with the product for which production parts are being picked. Based on the product type, the policy handler rule engine 204 may select a policy that stipulates skills or a station (e.g., subsystem) that is used. In some cases, the policy can forbid a particular skill or station (e.g., subsystem) based on the product type.

By way of another example, an operator may want to use the AGV 210 in a specific location, such as a hall, for environmental imaging. The hall may be associated with an amount of light, such that a camera that is used with the AGV 210 to collect environmental images is selected based on the amount of light. Various policies can be configured, such that the appropriate camera or infrared light can be selected at runtime, based on the specific location and/or an amount of light associated with operation of the AGV 210. For example, infrared light may be selected when the amount of light is below a certain threshold, in accordance with a policy. Conversely, a camera may be selected when the amount of light is above a certain threshold, in accordance with the policy. In particular, for example, a request message may indicate a location or hall associated with the intended operation of the AGV 210. Based on the location, the policy handler rule engine 204 may select a policy that stipulates a camera or light that is used to collect images.

By way of yet another example, various policies can be configured that relate to, or limit, the speed or acceleration of the AGV 210. For example, a request message may indicate a location or hall associated with the intended operation of the AGV 210. Based on the location, the policy handler rule engine 204 may select a policy that stipulates a maximum speed or acceleration at which the AGV 210 can operate within the location. For example, each location may be associated with hardware/devices within the location, and/or people within the location. Thus, a policy may indicate that a slower speed or acceleration is implemented at a first location, as compared to a faster speed or acceleration that can be implemented at a second location that is less crowded (e.g., with devices and/or people) than the first location. For instance, the second location may be larger than the first location, have less object than the first location, or otherwise have less potential for collision than the first location. Such policies can be implemented during runtime so as to ensure safety and avoid collisions between the AGV 210 and various objects within the location. For example, the policy may select a configuration of the AGV 210 based on the location or hall in which the AGV 210 operates. Similarly, the policy might forbid a particular configuration of the AGV 210 based on the location or hall in which AGV 210 operates. In some examples, an operator may want to fine tune parameters for a particular environment. By way of example, the maximum speed of an AGV within a particular location may be adjusted or fine-tuned until operators are satisfied or other conditions are attained.

With continuing reference to FIG. 2, in accordance with an example, at 220, the control module 106 receives messages from consumers of services or skills. For example, product orders can be received by the control module 106. In some cases, a product order at 220 can be generated on one or more engineering applications that are deployed on the cloud that is in communication with the control module 106. In various examples, the product order at 220 can define a small quantity for production, an order that is manufactured in a single run, or the like, so as define a lot size one product order. In some cases, such lot size one product orders can rely on a digital twin to fulfill the order. In particular, for example, the automation system 200 can include various physical entities, such as actuators, which change and control the real world's state so as to fulfill the order. The digitalized state of such physical entities can be preserved in a digital twin, which can refer to the process image of the current state of the physical system. In some examples, a request for skills is received at 220. The automation system 200, for instance the control module 106, can determine production or skill needs based on the product order or skills request at 220.

In an example, still referring to FIG. 2, the control module 106 can obtain (at 220) a first request for a first automation skill. Based on the first request, at 222, the control module 106 can send a discovery call for identifying machines within the industrial system capable of providing the first automation skill. The policy handler rule engine 204 can intercept the discovery call or can otherwise be invoked by the control module 106. Based on the discovery call or invocation, the policy handler rule engine (at 224) can determine a policy associated with the first request. Based on the policy and during runtime of the industrial system, a first machine of the plurality of machines can be selected. At 226, the control module 106 can trigger the first machine (e.g., Kuka 216, gantry 218, or AGV 210) to perform the first automation skill.

In another example, the control module 106 can operate on the AGV 210. Thus, the control module 106 of the AGV 210 can receive a request, for example, that instructs the AGV 210 to travel to a particular location. Based on the request, the AGV 210 can determine particular parameters associated with performing the request. For example, the control module 106 of the AGV 210 can use the policy handler rule engine 204 to determine a policy associated with the request. Based on the policy and during runtime of the AGV 210, various parameters associated with the request can be selected, such as speed, path, acceleration, or the like. Thus, the control module 106 of the AGV 210 can instruct and control the AGV 210 to operate in accordance with the parameters of the policy.

In some examples, during runtime, the system 200 can identify a change in policy associated with the first request. For example, based on the change in policy associated with the first request, the control module 106 can select a second machine of the plurality of machines, and trigger the second machine to perform the first automation skill. In another example, the control module 106 can obtain a second request (at 220) for the first automation skill. Further, based on the policy and during runtime of the industrial system, the control module can select a second machine of the plurality of machines that is different than the first machine, and trigger the second machine (at 226) to perform the first automation skill. In some cases, the policy can define rules for selecting the machines, and the rules can be based on a location in which the first automation skill is performed.

Still referring to FIG. 2, the automation system 200 can include various machines, for instance a plurality of pay-per-use machines. The machines can be associated with a plurality of automation services or skills. The machines 114 can provide skills or functions as a service, and can be discovered by the control module 106. Unless otherwise specified, skills, functions, and services can be used interchangeably herein without limitation.

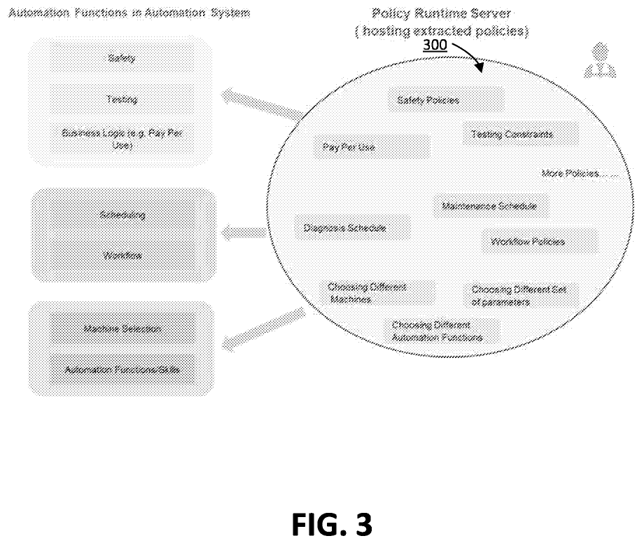

Referring also to FIG. 3, the automation system may define a policy manager, for instance a centralized policy manager 300, which can leverage modular automation and can host policies and rules for a complete automaton system. As shown in FIG. 3, embodiments are not limited to the example policies or functions described herein, but may be applied to all levels of an automation system, so as define adaptive behavior for the system. In particular, for example, the policy manager 300 may include various polices related to different categories of system configuration and operations, such as safety, pay-per use, testing, maintenance, diagnosis, workflow, policies related to choosing machines, policies related to choosing parameters (e.g., AGV policies), policies related to choosing automation functions, or the like. Further, each of the policies hosted on the policy handler 300 that can be accessed by the policy hander rule engine 204, which can be distributed and coupled to the policy manager 300, or can comprise the policy manager 300 itself. Such policies can determine or influence various operations or configurations, such as for example and without limitation, safety (e.g., operational speeds based on light, presence of humans, etc.), testing operations, business logic, schedules (e.g., downtimes, particular machine operations), workflows, machine selection, selection of automation functions/skills, or the like.

Thus, without being bound by theory, in accordance with various embodiments, policies include rules for decision-making logic, such that engineering tasks for adaptive behavior are performed during commissioning and runtime. In particular, business and operational policies can be separated from automation functions, such that policies (e.g., control logic) can also be tested.

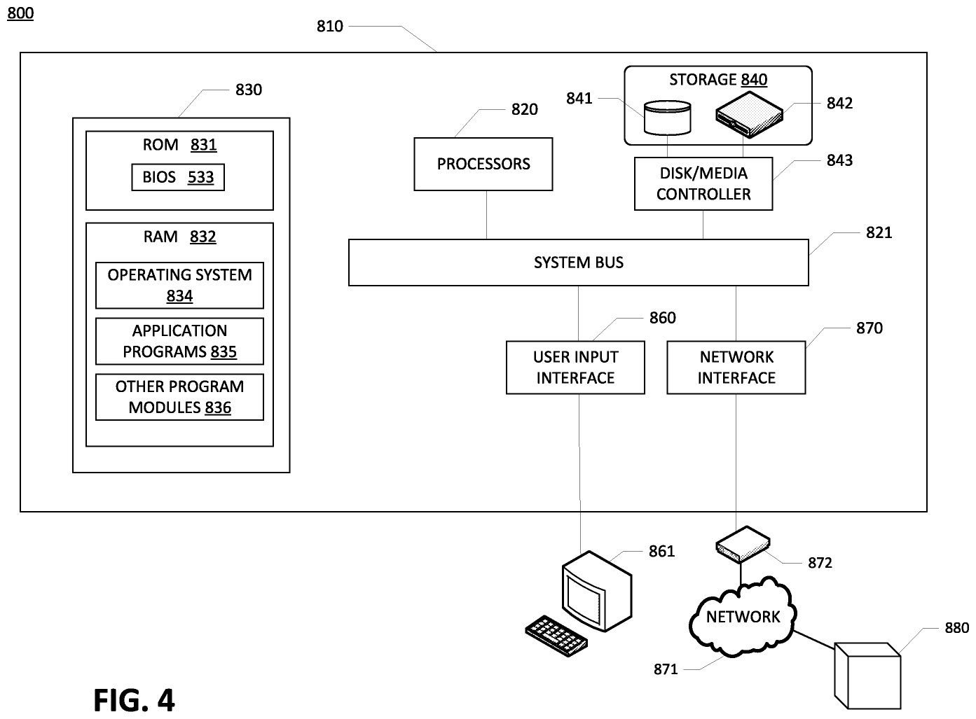

FIG. 4 illustrates an example of a computing environment within which embodiments of the present disclosure may be implemented. A computing environment 800 includes a computer system 810 that may include a communication mechanism such as a system bus 821 or other communication mechanism for communicating information within the computer system 810. The computer system 810 further includes one or more processors 820 coupled with the system bus 821 for processing the information. The industrial system 100 may include, or be coupled to, the one or more processors 820.

The processors 820 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 820 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 821 may include at least one of a system bus, a memory bus, an address bus, or a message bus, and may permit exchange of information (e.g., data (including computer-executable code), signaling, etc.) between various components of the computer system 810. The system bus 821 may include, without limitation, a memory bus or a memory controller, a peripheral bus, an accelerated graphics port, and so forth. The system bus 821 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 4, the computer system 810 may also include a system memory 830 coupled to the system bus 821 for storing information and instructions to be executed by processors 820. The system memory 830 may include computer readable storage media in the form of volatile and/or nonvolatile memory, such as read only memory (ROM) 831 and/or random access memory (RAM) 832. The RAM 832 may include other dynamic storage device(s) (e.g., dynamic RAM, static RAM, and synchronous DRAM). The ROM 831 may include other static storage device(s) (e.g., programmable ROM, erasable PROM, and electrically erasable PROM). In addition, the system memory 830 may be used for storing temporary variables or other intermediate information during the execution of instructions by the processors 820. A basic input/output system 833 (BIOS) containing the basic routines that help to transfer information between elements within computer system 810, such as during start-up, may be stored in the ROM 831. RAM 832 may contain data and/or program modules that are immediately accessible to and/or presently being operated on by the processors 820. System memory 830 may additionally include, for example, operating system 834, application programs 835, and other program modules 836. Application programs 835 may also include a user portal for development of the application program, allowing input parameters to be entered and modified as necessary.

The operating system 834 may be loaded into the memory 830 and may provide an interface between other application software executing on the computer system 810 and hardware resources of the computer system 810. More specifically, the operating system 834 may include a set of computer-executable instructions for managing hardware resources of the computer system 810 and for providing common services to other application programs (e.g., managing memory allocation among various application programs). In certain example embodiments, the operating system 834 may control execution of one or more of the program modules depicted as being stored in the data storage 840. The operating system 834 may include any operating system now known or which may be developed in the future including, but not limited to, any server operating system, any mainframe operating system, or any other proprietary or non-proprietary operating system.

The computer system 810 may also include a disk/media controller 843 coupled to the system bus 821 to control one or more storage devices for storing information and instructions, such as a magnetic hard disk 841 and/or a removable media drive 842 (e.g., floppy disk drive, compact disc drive, tape drive, flash drive, and/or solid state drive). Storage devices 840 may be added to the computer system 810 using an appropriate device interface (e.g., a small computer system interface (SCSI), integrated device electronics (IDE), Universal Serial Bus (USB), or FireWire). Storage devices 841, 842 may be external to the computer system 810.

The computer system 810 may also include a field device interface 865 coupled to the system bus 821 to control a field device 866, such as a device used in a production line. The computer system 810 may include a user input interface or GUI 861, which may comprise one or more input devices, such as a keyboard, touchscreen, tablet and/or a pointing device, for interacting with a computer user and providing information to the processors 820.

The computer system 810 may perform a portion or all of the processing steps of embodiments of the invention in response to the processors 820 executing one or more sequences of one or more instructions contained in a memory, such as the system memory 830. Such instructions may be read into the system memory 830 from another computer readable medium of storage 840, such as the magnetic hard disk 841 or the removable media drive 842. The magnetic hard disk 841 and/or removable media drive 842 may contain one or more data stores and data files used by embodiments of the present disclosure. The data store 840 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 820 may also be employed in a multi-processing arrangement to execute the one or more sequences of instructions contained in system memory 830. In alternative embodiments, hard-wired circuitry may be used in place of or in combination with software instructions. Thus, embodiments are not limited to any specific combination of hardware circuitry and software.

As stated above, the computer system 810 may include at least one computer readable medium or memory for holding instructions programmed according to embodiments of the invention and for containing data structures, tables, records, or other data described herein. The term “computer readable medium” as used herein refers to any medium that participates in providing instructions to the processors 820 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 841 or removable media drive 842. Non-limiting examples of volatile media include dynamic memory, such as system memory 830. Non-limiting examples of transmission media include coaxial cables, copper wire, and fiber optics, including the wires that make up the system bus 821. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 800 may further include the computer system 810 operating in a networked environment using logical connections to one or more remote computers, such as remote computing device 880. The network interface 870 may enable communication, for example, with other remote devices 880 or systems and/or the storage devices 841, 842 via the network 871. Remote computing device 880 may be a personal computer (laptop or desktop), a mobile device, a server, a router, a network PC, a peer device or other common network node, and typically includes many or all of the elements described above relative to computer system 810. When used in a networking environment, computer system 810 may include modem 872 for establishing communications over a network 871, such as the Internet. Modem 872 may be connected to system bus 821 via user network interface 870, or via another appropriate mechanism.

Network 871 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 810 and other computers (e.g., remote computing device 880). The network 871 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 871.

It should be appreciated that the program modules, applications, computer-executable instructions, code, or the like depicted in FIG. 4 as being stored in the system memory 830 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 810, the remote device 880, and/or hosted on other computing device(s) accessible via one or more of the network(s) 871, may be provided to support functionality provided by the program modules, applications, or computer-executable code depicted in the figures and/or additional or alternate functionality. Further, functionality may be modularized differently such that processing described as being supported collectively by the collection of program modules depicted in the figures may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in the figures may be implemented, at least partially, in hardware and/or firmware across any number of devices.

It should further be appreciated that the computer system 810 may include alternate and/or additional hardware, software, or firmware components beyond those described or depicted without departing from the scope of the disclosure. More particularly, it should be appreciated that software, firmware, or hardware components depicted as forming part of the computer system 810 are merely illustrative and that some components may not be present or additional components may be provided in various embodiments. While various illustrative program modules have been depicted and described as software modules stored in system memory 530, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method performed within an industrial system that comprises a plurality of machines that define respective hardware and automation skills associated with the hardware, the method comprising:
obtaining, by a control module of the industrial system, a first request for a first automation skill;
based on the first request, sending, by the control module, a discovery call for identifying machines within the industrial system capable of providing the first automation skill;
based on the discovery call, the policy handler rule engine determining a policy associated with the first request;
based on the policy and during runtime of the industrial system, selecting a first machine of the plurality of machines; and
triggering the first machine to perform the first automation skill.

2. The method as recited in claim 1, the method further comprising:
during runtime, identifying a change in policy associated with the first request.

3. The method as recited in claim 2, the method further comprising:
based on the change in policy associated with the first request, selecting a second machine of the plurality of machines; and
triggering the second machine to perform the first automation skill.

4. The method as recited in claim 1, the method further comprising:
obtaining, by the control module, a second request for the first automation skill;
based on the policy and during runtime of the industrial system, selecting a second machine of the plurality of machines that is different than the first machine; and
triggering the second machine to perform the first automation skill.

5. The method as recited in claim 4,
wherein the policy defines rules for selecting the machines, the rules based on a location in which the first automation skill is performed.

6. An industrial system, the industrial system comprising:
a processor; and
a memory storing instructions that, when executed by the processor, configure the system to:
obtain a first request for a first automation skill;
based on the first request, send a discovery call for identifying machines within the industrial system capable of providing the first automation skill;
based on the discovery call, determine a policy associated with the first request;
based on the policy and during runtime of the industrial system, select a first machine of the plurality of machines; and
trigger the first machine to perform the first automation skill.

7. The system as recited in claim 1, the memory further storing instructions that, when executed by the processor, further configure the system to:
during runtime, identify a change in policy associated with the first request.

8. The system as recited in claim 7, the memory further storing instructions that, when executed by the processor, further configure the system to:
based on the change in policy associated with the first request; selecting a second machine of the plurality of machines; and
triggering the second machine to perform the first automation skill.

9. The system as recited in claim 1, the memory further storing instructions that, when executed by the processor, further configure the system to:
obtain a second request for the first automation skill;
based on the policy and during runtime of the industrial system, select a second machine of the plurality of machines that is different than the first machine; and
trigger the second machine to perform the first automation skill.

10. The system as recited in claim 9,
wherein the policy defines rules for selecting the machines, the rules based on a location in which the first automation skill is performed.

11. An automatic guided vehicle (AGV), the AGV comprising:
a processor; and
a memory storing instructions that, when executed by the processor, configure the AGV to:
obtain a first request for operating the AGV;
based on the first request, determine a policy associated with the first request;
based on the policy and during runtime of the AGV, select a first parameter for operating the AGV; and
trigger the AGV to operate in accordance with the first parameter.

12. The AGV as recited in claim 11, the memory further storing instructions that, when executed by the processor, further configure the AGV to:
during runtime, identify a change in policy associated with the first request.

13. The AGV as recited in claim 12, the memory further storing instructions that, when executed by the processor, further configure the AGV to:
based on the change in policy associated with the first request; selecting a second parameter for operating the AGV; and
triggering the AGV to operate in accordance with the second parameter instead of the first parameter.

14. The AGV as recited in claim 11, wherein the first and second parameters define respective maximum speeds for operating the AGV.

15. The AGV as recited in claim 11,
wherein the policy defines rules for operating the AGV, the rules based on a location in which the AGV is operational.
